(19) United States
(12) Patent Application Publication
(10) Pub. No.: US 2006/0242035 A1
(43) Pub. Date: Oct. 26, 2006

(54) Data analysis method and system

(75) Inventors: Steven Corbett, Bristol (GB); Christopher Evans, Bristol (GB)

Correspondence Address: BINGHAM MCCUTCHEN LLP, 3000 K STREET, NW, BOX IP, WASHINGTON, DC, 20007, US

(73) Assignee: Oracle International Corporation

(21) Appl. No.: 11/109,817

(22) Filed: Apr. 20, 2005

(51) Int. Cl. H04M 15/00; G07F 19/00

(52) U.S. Cl. 705/34; 705/28

(57) ABSTRACT

A method for automatically analysing a data set is disclosed. The data set comprises a plurality of data items together representing an aspect of the performance of an entity. Each item has a descriptor value within each of one or more categories of description data and associated performance data values. The method comprises selecting each unique descriptor value in turn and for each unique descriptor value: a) selecting every data item having said descriptor value; b) calculating a key performance indicator (KPI) value for the data items selected in step (a); and identifying any of the unique descriptor values for which the KPI value fails to meet a predetermined performance criterion.

This invention relates to a method and system for analysing a data set that represents one or more aspects of the performance of an entity. In particular, it relates to a method and system for determining the cause of a key performance indicator (KPI) failing to meet a performance target.

KPIs are used by an entity such as a company or a school to measure and monitor various aspects of the performance of their operation. A specific KPI is normally assigned a target value. For example, a school may wish to monitor the proportion of its pupils achieving a pass grade in examinations and may set a target value of 75%. Alternatively, a company may wish to monitor its profit margin, setting a target value of 30% for example.

Normally, a KPI will be calculated from a set of data which represent an aspect of the performance of an entity. The KPI is calculated by a software product which will display the value of the KPI to the user along with some kind of indication to show whether the value meets the performance target. For example, the value may be displayed in a red colour if it does not meet the performance target and displayed in a green colour if it does. Additionally, the user interface may indicate whether the KPI value has been rising, falling or remaining static.

If a KPI does not achieve its target value then an employee responsible for management of that aspect of an entity's operation would be expected to investigate the failure of performance, and preferably to take remedial action to correct it. Typically, the employee would investigate the failure by causing the software product to generate more detailed reports, for example showing the profit margin variation from month to month over the previous year, or indeed for different types of products sold by the company. Obviously, this kind of investigation can be very time consuming and tedious since normally large amounts of data will be involved. There is therefore a need to be able to highlight the cause of a KPI failing to meet its target value in a more expeditious fashion.

In accordance with one aspect of the present invention, there is provided a method for automatically analysing a data set, the data set comprising a plurality of data items together representing an aspect of the performance of an entity, each item having a descriptor value within each of one or more categories of description data and associated performance data values, the method comprising selecting each unique descriptor value in turn and for each unique descriptor value:

a) selecting every data item having said descriptor value;

b) calculating a key performance indicator (KPI) value for the data items selected in step (a);

and identifying any of the unique descriptor values for which the KPI value fails to meet a predetermined performance criterion.

In accordance with a second aspect of the invention, there is provided a system for automatically analysing a data set, the system comprising a processor connected to a store, wherein the processor is adapted to retrieve a set of data from the store, the data set comprising a plurality of data items together representing an aspect of the performance of an entity, each item having a descriptor value within each of one or more categories of description data and associated performance data values, and to select each unique descriptor value in turn and for each unique descriptor value:

a) to select every data item with said descriptor value;

b) to calculate a key performance indicator (KPI) value for the data items selected in step (a);

and identify any of the unique descriptor values for which the KPI value fails to meet a predetermined performance criterion.

Hence, the invention provides a method and system that overcome the disadvantages of the prior art by automatically calculating a key performance indicator for all data items associated with each other by virtue of having the same descriptor value. Comparison of each calculated KPI value with the predetermined performance criteria thereby allows the root cause of failure to be quickly ascertained.

Typically, the data set is stored on a database.

In one embodiment, a descriptor value in the first category indicates a first product type and a descriptor value in a second category indicates a refail outlet location, and the associated performance data values indicate the purchase cost and sales revenue for each product sold.

In this embodiment, the KPI typically represents the profit margin. The profit margin is normally calculated by aggregating the performance data values for every data item selected in step (a) to generate a total revenue value and a total cost value for said descriptor value, and dividing the difference between the total revenue value and total cost value by the total revenue value.

The KPI value may fail to meet the predetermined performance criterion by falling below a threshold value. Alternatively, it may fail to meet the predetermined performance criterion by falling outside a range of values, or exceeding a threshold value.

Typically, the unique descriptor value for which the KPI values had failed to meet the predetermined performance criterion are identified by comparing each KPI value calculated in step (b) with the predetermined performance criterion.

Preferably, the unique descriptor values and associated KPI values for the category of description data having the lowest proportion of unique descriptor values for which the KPI value fails to meet the predetermined performance criterion are displayed to a user.

In accordance with a third aspect of the present invention, there is provided a computer program comprising computer program code means adapted to perform the steps of the first aspect of the invention when said program is run on a computer.

In a fourth aspect of the present invention, there is provided a computer program product comprising computer program code means adapted to perform the steps of the first aspect of the invention when said program is run on a computer.

An embodiment of the invention will now be described with reference to the accompanying drawings, in which:-

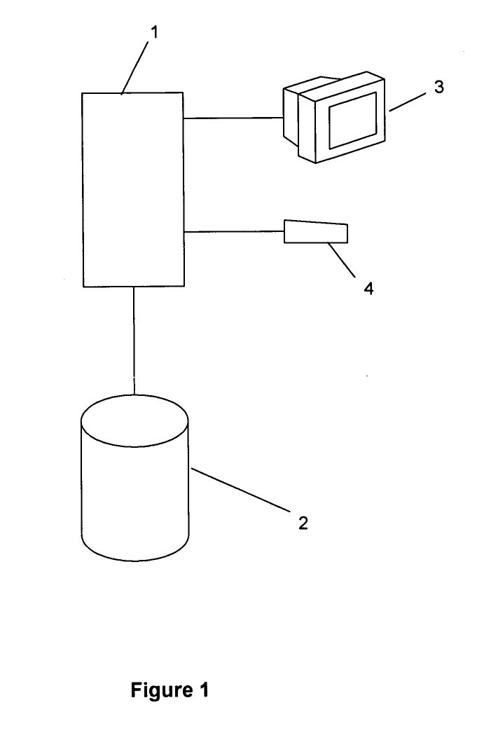

FIG. 1 shows a system suitable for executing software adapted to perform the invention;

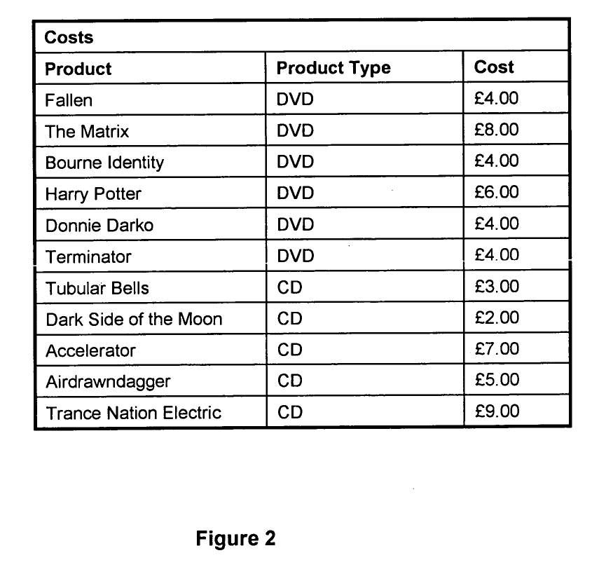

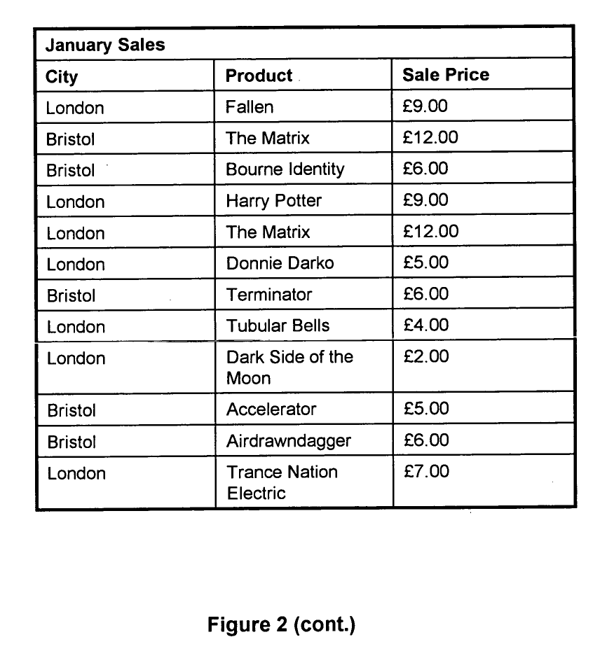

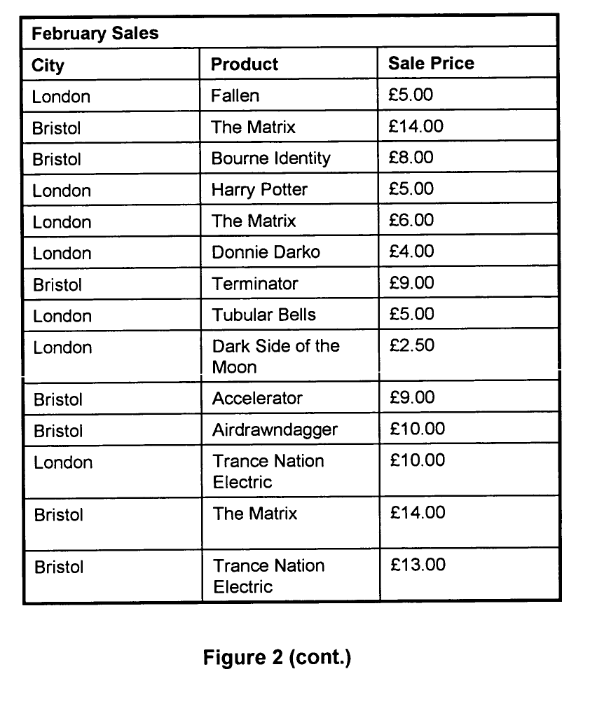

FIG. 2 shows an example of a data set for the purposes of illustrating the invention; and,

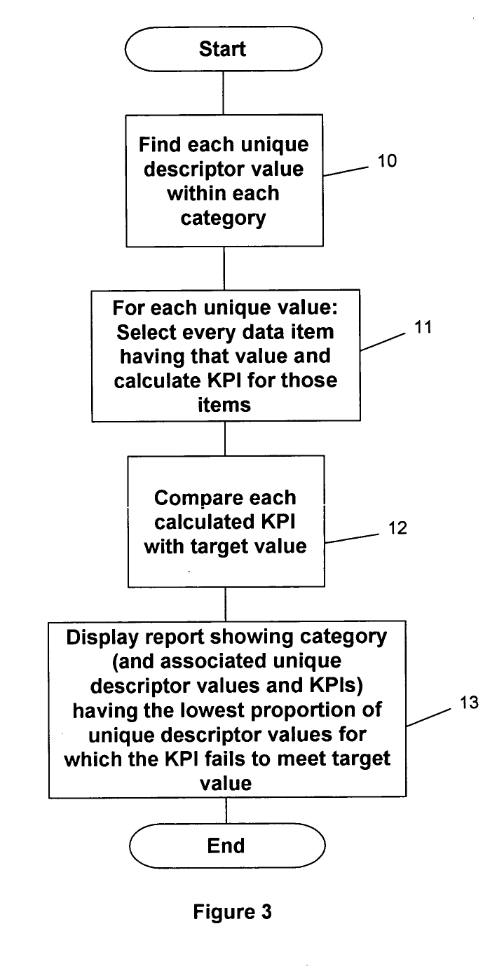

FIG. 3 shows a flow chart of the method of the embodiment.

FIG. 1 shows a schematic view of a system suitable for running software adapted to perform the invention. The system comprises a processor 1 connected to a store 2, such as a database, and to a display 3 and user input device 4.

FIG. 2 shows example data for the purposes of illustrating the invention. These data are arranged in three tables stored on the database on store 2. The first table is entitled “Costs”, and the second and third are entitled “January Sales” and “February Sales” respectively. The example data represent the sales made by London and Bristol branches of a chain of shops which sell CDs and DVDs. They also indicate the particular product type (i.e. CD or DVD) that each product falls into, and the purchase cost of that product. For example, from the “Costs” table it can be seen that “The Matrix” is a DVD costing £8.00 to the company, and from the “January Sales” table it can be seen that a copy was sold from the Bristol store in January at a price of £12.00.

In this example, in order to monitor the profitability of the chain of stores, the managing director calculates the profit margin. It is this that is the KPI in this example. The profit margin is defined as the profit expressed as a proportion of revenue, as shown by the following formula:

$$P = \frac{( R - C )}{R}$$

where: P=Profit Margin, R=Revenue, C=Cost

In this example, the target value for the profit margin KPI is set at 30%, and remedial action must be taken if it falls lower than that value. Initially, the managing director will cause the software to generate a report indicating the overall profit margin for the months of January and February. The software responds by calculating the total revenue in January (i.e. by adding all the Sale Price figures in the “January Sales” table together), and calculating the corresponding cost by reference to the “Costs” table. The results of these calculations are then used in the above formula to calculate the KPI. A similar procedure is performed for the month of February using the “February Sales” table. In this case, the revenue and costs for January are £83 and £64 respectively. In February, the revenue and costs are £114.50 and £81 respectively. The profit margin is therefore 23% for January and 29% for February. In both cases the KPI falls below the threshold of 30%, and so the managing director will want to investigate the cause of this in order to take suitable remedial action.

In order to make this investigation, the managing director will instruct the software to determine the cause of the underperforming profit margin KPI, and the software will respond by performing the method shown in the flow chart of FIG. 3.

The first stage of this flow chart is step 10 in which the software finds each unique descriptor value within each category. In this example, the categories are “City” (having unique descriptor values of “London” and “Bristol”), “Product Type” (having unique descriptor values of “DVD” and “CD”), and “Product”. The “Product” category is ignored by the software in this example since “Product Type” is a higher level summary of “Product”. Therefore, step 10 will discover four different unique descriptor values in two categories.

In step 11, each of these four values is selected in turn. Every data item in each of the “January Sales” and “February Sales” tables having the currently-selected value is selected to form respective calculation data sets, and KPI values are then calculated for that descriptor value. Thus, for the “London” descriptor value, the following data items will be combined to form a calculation set from the “January Sales” table:

January Sales

| City | Product | Sale Price |
|---|---|---|
| London | Fallen | £9 |
| London | Harry Potter | £9 |
| London | The Matrix | £12 |
| London | Donnie Darko | £5 |
| London | Tubular Bells | £4 |
| London | Dark Side of the Moon | £2 |
| London | Trance Nation Electric | £7 |

The software then calculates the KPI for this calculation data set, again retrieving the cost values from the “Costs” table. The KPI value is 25%. A similar procedure is followed for each of the other three unique descriptor values of “Bristol”, “CD” and “DVD” to generate associated KPI values of 20%, −8% and 36% respectively. A similar procedure is followed with respect to the “February Sales” table.

In actual fact, the software will generate two reports for the “January Sales” table and two reports for the “February Sales” table. These would not normally be shown to a user, but are shown below for clarity:

| | | | |
|---|---|---|---|
| City | Profit Margin | Product Type | Profit Margin |

January Sales:
Overall Profit Margin: 23%

| | | | |
|---|---|---|---|
| London | 25% | CD | −8% |
| Bristol | 20% | DVD | 36% |

February Sales:
Overall Profit Margin: 29%

| | | | |
|---|---|---|---|
| London | 4% | CD | 29% |
| Bristol | 42% | DVD | 29% |

As can be seen, in the “January Sales” report all of the rows in the “City” column show the KPI as underperforming compared to only 50% of the rows in the “Product Type” column. Therefore, in step 12 when each calculated KPI value is compared with the target, it will be determined that the “Product Type” category has the lowest proportion of unique descriptor values for which the KPI falls below the target. Therefore, it is this category (and in particular CD sales) that are the root cause of the underperforming KPI, and the following report will be displayed to the user in step 13:

Significant Detail Report

| Product Type | Profit Margin |
|---|---|
| CD | −8% |
| DVD | 36% |
| Overall Profit Margin | 23% |

From this report the managing director can see that it is CD sales that are having the biggest effect on the overall profit margin in the “January Sales” table, and he can take suitable remedial action.

In the case of the “February Sales” report shown above, 50% of the rows in the “City” column show the KPI underperforming compared to 100% of the rows in the “Product Type” column. Consequently, in step 12 it will be determined that it is the “City” column and associated descriptor values that contain the significant detail (since the “City” column has the lowest proportion of KPI values that fail to meet the target) so these are shown to the user in step 13 by display of the following report:

Significant Detail Report

| Product Type | Profit Margin |
|---|---|
| London | 4% |
| Bristol | 42% |
| Overall Profit Margin | 29% |

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

1. A method for automatically analysing a data set, the data set comprising a plurality of data items together representing an aspect of the performance of an entity, each item having a descriptor value within each of one or more categories of description data and associated performance data values, the method comprising selecting each unique descriptor value in turn and for each unique descriptor value:
a) selecting every data item having said descriptor value;
b) calculating a key performance indicator (KPI) value for the data items selected in step (a);
and identifying any of the unique descriptor values for which the KPI value fails to meet a predetermined performance criterion.

2. A method according to claim 1, wherein the data set is stored on a database.

3. A method according to claim 1, wherein a descriptor value in a first category indicates a product type and a descriptor value in a second category indicates a retail outlet location, and the associated performance data values indicate the purchase cost and sales revenue for each product sold.

4. A method according to claim 3, wherein the KPI value represents the profit margin.

5. A method according to claim 4, wherein the profit margin is calculated by aggregating the performance data values for every data item selected in step (a) to generate a total revenue value and a total cost value for said descriptor value, and dividing the difference between the total revenue value and total cost value by the total revenue value.

6. A method according to claim 1, wherein the KPI value fails to meet the predetermined performance criterion if the KPI value falls below a threshold value.

7. A method according to claim 1, wherein the KPI value fails to meet the predetermined performance criterion if the KPI value falls outside a range of values.

8. A method according to claim 1, wherein the KPI value fails to meet the predetermined performance criterion if the KPI value falls exceeds a threshold value.

9. A method according to claim 1, wherein the unique descriptor values for which the KPI values have failed to meet the predetermined performance criterion are identified by comparing each KPI value calculated in step (b) with the predetermined performance criterion.

10. A method according to claim 1, wherein the unique descriptor values and associated KPI values for the category of description data having the lowest proportion of unique descriptor values for which the KPI value fails to meet the predetermined performance criterion are displayed to a user.

11. A system for automatically analysing a data set, the system comprising a processor connected to a store, wherein the processor is adapted to retrieve a set of data from the store, the data set comprising a plurality of data items together representing an aspect of the performance of an entity, each item having a descriptor value within each of one or more categories of description data and associated performance data values, and to select each unique descriptor value in turn and for each unique descriptor value:
a) to select every data item with said descriptor value;
b) to calculate a key performance indicator (KPI) value for the data items selected in step (a);
and identify any of the unique descriptor values for which the KPI value fails to meet a predetermined performance criterion.

12. A system according to claim 11, wherein the store is a database on which the data set is stored.

13. A system according to claim 11, wherein a descriptor value in a first category indicates a product type and a descriptor value in a second category indicates a retail outlet location, and the associated performance data values indicate the purchase cost and sales revenue for each product sold.

14. A system according to claim 13, wherein the KPI value represents the profit margin.

15. A system according to claim 14, wherein the processor is further adapted to calculate the profit margin by aggregating the performance data values for every data item selected in step (a) to generate a total revenue value and a total cost value for said descriptor value, and to divide the difference between the total revenue value and total cost value by the total revenue value.

16. A system according to claim 11, wherein the KPI value fails to meet the predetermined performance criterion if the KPI value falls below a threshold value.

17. A system according to claim 11, wherein the KPI value fails to meet the predetermined performance criterion if the KPI value falls outside a range of values.

18. A system according to claim 11, wherein the KPI value fails to meet the predetermined performance criterion if the KPI value falls exceeds a threshold value.

19. A system according to claim 11, wherein the processor is further adapted to identify the unique descriptor values for which the KPI values have failed to meet the predetermined performance criterion by comparing each KPI value calculated in step (b) with the predetermined performance criterion.

20. A system according to claim 11, wherein the processor is further adapted to display to a user the unique descriptor values and associated KPI values for the category of description data having the lowest proportion of unique descriptor values for which the KPI value fails to meet the predetermined performance criterion.

21. A computer program comprising computer program code means adapted to perform the steps of claim 1 when said program is run on a computer.

22. A computer program product comprising computer program code means adapted to perform the steps of claim 1 when said program is run on a computer.
